(19) United States
(12) Patent Application Publication
(10) Pub. No.: US 2025/0321621 A1
(43) Pub. Date: Oct. 16, 2025

(54) Programmable Display Cube Device

(71) Applicant: Predrag Ilic, Las Vegas, NV (US)

(72) Inventor: Predrag Ilic, Las Vegas, NV (US)

(21) Appl. No.: 19/064,549

(22) Filed: Feb. 26, 2025

Related U.S. Application Data
(60) Provisional application No. 63/634,014, filed on Apr. 15, 2024.

(51) Int. Cl. G06F 1/16; G06F 1/3231

(52) U.S. Cl. CPC G06F 1/1647; G06F 1/1605; G06F 1/3231; G06F 2200/1614; G06F 2200/1637

(57) ABSTRACT

A programmable display cube device is provided with display screens on two or more rotatable outer faces of the display cube device to enhance a user's cognitive and motor skills. The programmable display cube device is configured to display and dynamically update multimedia content on each display screen according to a sequence of rotational inputs by the user. The multimedia content is prescribed by one or more programs (i.e., educational lesson plans) encompassing STEM, language arts, history, and the like. Educational programs include matching puzzles, memory games, and timed assessments in various subjects. The programmable display cube device may be communicatively connected to a client device (i.e., a mobile device operated by an education professional) to receive new educational programs and generate data-driven insights tracking the user's educational progress.

### CROSS-REFERENCE TO RELATED APPLICATION

This application claims benefit of, and priority to, U.S. Provisional Application No. 63/634,014, filed Apr. 15, 2024, which is incorporated herein by reference in its entirety.

### BACKGROUND

### 1. Technical Field

The present disclosure relates generally to an educational cube device, and, in particular, to a programmable display cube device capable of manipulation by a user to respond to audiovisual prompts.

### 2. Background

In recent years, technology-driven teaching methods have been of significant interest in the field of education, fostering more interactive, personalized, and collaborative learning experiences. Online learning platforms have expanded access to a wealth of educational resources. Adaptive technologies allow lessons to be customized to an individual student's needs, bolstering his or her performance. Collaboration is also enhanced through digital platforms that facilitate group activities and cultural exchanges. These digital tools provide valuable analytics for data-driven decision making in educational planning and strategies, further improving the quality of education.

### SUMMARY

As the field of education has evolved, applications of cognitive science in science, technology, engineering, and math (STEM) education have become increasingly prominent, providing insights into students' learning mechanisms and showcasing effective strategies for information retention. Research indicates that students assimilate and retain knowledge better when they are stimulated with hands-on experiments and other active problem-solving tasks. Visual aids like graphs and diagrams have also proven beneficial in facilitating student comprehension.

Similarly, contemporary research in language acquisition indicates that techniques such as spaced repetition, a method of revisiting learned material at gradually expanding intervals, enhances vocabulary retention. Combining two or more teaching techniques (e.g., spaced repetition and visual aids) can help students to grasp the contextual implications of words and phrases. These findings inform new teaching strategies to promote deeper understanding and information retention. Educators can tailor their teaching methods to accommodate the specific learning needs of their students, including those with learning difficulties such as dyslexia, dyscalculia, autism, and attention-deficit/hyperactivity disorder (ADHD).

Educational tools that integrate spatial elements can be one aspect of a contemporary lesson plan, offering students an interactive learning experience. Disclosed herein is one such educational tool, a programmable display cube device provided with interactive display screens on two or more rotatable outer faces of the device. The programmable display cube device is configured to display and dynamically update multimedia content on each display screen according to a sequence of rotational inputs by a user, enhancing the user's cognitive and motor skills. In one embodiment, the multimedia content is prescribed by one or more educational programs (e.g., software applications implementing an educator's lesson plan) encompassing STEM, language arts, history, and the like. Examples of such educational programs include matching puzzles, memory games, and timed assessments in various subjects.

In some embodiments, a programmable display cube device is communicatively connected (e.g., paired) to a client device (e.g., a mobile device operated by an education professional) to receive educational content and generate data-driven insights into the user's educational progress. In some instances, the programmable display cube device is configured to access educational programs from an online learning platform (e.g., in response to a request from the client device). The programmable display cube device represents an engaging, accessible educational tool appropriate for individual instruction and group lessons.

In various configurations, certain actions associated with the educational program(s) are performed by the display cube device or one or more client devices (e.g., smartphones, tablets, or laptops). For example, an educational program may cause the display cube device to render text and images in a graphical user interface of one or more display screens. The display cube device (or a paired client device) may access an online learning platform to download user-generated applications (e.g., games, puzzles, assessments, or other customized study aids) for display of additional content on the display cube device. Accordingly, developers, educators, and students can create their own educational programs to customize multimedia content output by the display cube device.

In an embodiment, the display cube device is a programmable electronic display device including a spherical center piece around which is disposed a plurality of pieces (also referred to as “peripheral pieces”) adapted to rotate, in response to user input, around two or more axes of the center piece. In one embodiment, each face of the display cube device is a substantially planar surface made up of four corner pieces, four edge pieces, a display panel (e.g., screen), and a face plate. In another embodiment, the display panel is recessed behind an opening in the face plate. The plurality of peripheral pieces collectively form a cube structure around the spherical center piece, the cube structure having a plurality of rows and a plurality of columns associated with each face.

A user provides inputs to the display cube device by manipulating a subset of the peripheral pieces (e.g., by rotating a row to the left or right or by rotating a column upward or downward) based on content (e.g., multimedia content) displayed on one or more of the display panels. For example, if a display panel of a main face of the device displays a question, the user may rotate a subset of the peripheral pieces which form a row or a column of the cube structure to provide an answer (e.g., a left turn might indicate a “true” response to the displayed question while a right turn might indicate that the user believes the answer is “false”). In certain embodiments, one or more display cube devices are communicatively connected to a client device running a cube device application through which a user of the client device (e.g., an educator directing a lesson via a mobile device) selects or provides content for display on the cube device(s).

The display cube device is particularly well-suited to STEM, language learning, and special education lessons, as will be discussed herein. However, the adaptable nature of the display cube device lends itself to various other uses. For example, in various embodiments, the display cube device may be an artistic tool, a gaming controller, an augmented or virtual reality (AR/VR) input device, or a music controller. In some embodiments, usage data of the display cube device may be used to train an artificial intelligence (AI) model.

In some aspects, the techniques described herein relate to a programmable display cube device including: a center piece including a microprocessor, a power source, and a communications module for controlling display of content by the display cube device; a plurality of peripheral pieces disposed around the center piece and configured to rotate about a first axis of the center piece in response to manipulation of the device by a user; and one or more display screens provided on one or more exterior faces of the display cube device and communicatively connected to the microprocessor; wherein each display screen is centered on a corresponding axis of the center piece such that a subset of the plurality of peripheral pieces is rotatable about the first axis of the center piece and one or more additional axes of the center piece.

In some aspects, the techniques described herein relate to a programmable display cube device, wherein the display cube device is communicatively connected to at least one client device; and wherein content is displayed on one or more display screens of the display cube device responsive to one or more control signals generated by the client device.

In some aspects, the techniques described herein relate to a programmable display cube device, wherein the display cube device is further configured to: detect an angle of rotation of the plurality of peripheral pieces; generate rotational data including the angle of rotation and an axis of rotation; receive, by the communications module, one or more control signals from the client device responsive to the rotational data; and update, by the microprocessor, content on one or more display screens responsive to the one or more control signals received from the client device.

In some aspects, the techniques described herein relate to a programmable display cube device, further including two or more displays screens provided on two or more outer faces of the display cube device, wherein each of the two or more display screens are centered on a respective axis of the center piece.

In some aspects, the techniques described herein relate to a programmable display cube device, wherein the display cube device is operating in an energy-saving mode; and wherein a user-facing display screen of the two or more display screens is configured to display content to a user, and wherein a non-user-facing display screen of the two or more display screens is disabled in the energy-saving mode.

In some aspects, the techniques described herein relate to a programmable display cube device, wherein the microprocessor is configured to update content displayed on the two or more display screens based on relative rotation of the two or more outer faces of the display cube device.

In some aspects, the techniques described herein relate to a programmable display cube device, wherein each exterior face of the display cube device is provided with a single display screen centered on a respective axis; and wherein the microprocessor is configured to update content displayed on one or more of the display screens responsive to an angle of rotation of the plurality of peripheral pieces and an orientation of the display cube device.

In some aspects, the techniques described herein relate to a programmable display cube device, wherein the communications module is wirelessly connected to the client device by way of Bluetooth, Wi-Fi, near-field communication (NFC), or ultra-wideband (UWB) protocols.

In some aspects, the techniques described herein relate to a programmable display cube device, wherein the communications module is configured to transmit positional or orientational data of the display cube device to the client device.

In some aspects, the techniques described herein relate to a non-transitory computer-readable storage medium including stored instructions, the instructions when executed by a computing system cause the computing system to perform operations including: detecting a change in an angle of rotation of a peripheral piece indicating input by a user; encoding rotational data including the angle of rotation and an axis of rotation of the peripheral piece; accessing a content library responsive to the input by the user; and updating at least one display screen with one or more items of content from the content library according to the encoded rotational data.

In some aspects, the techniques described herein relate to a non-transitory computer-readable storage medium, wherein accessing the content library further includes downloading multimedia content from a content platform.

In some aspects, the techniques described herein relate to a non-transitory computer-readable storage medium, wherein updating a display screen with one or more items of content from the content library further includes: displaying, by the at least one display screen, a visual component of the multimedia content; and outputting, by an signal generation device communicatively connected to the computing system, an audio component of the multimedia content.

In some aspects, the techniques described herein relate to a non-transitory computer-readable storage medium, wherein the instructions further include instructions that when executed by the computing system cause the computing system to perform operations including: transmitting the encoded rotational data to a client device; and receiving, from the client device, a control signal including a display identifier and a content identifier indicating updated content to be displayed on a corresponding display screen.

In some aspects, the techniques described herein relate to a non-transitory computer-readable storage medium, wherein updating at least one display screen with one or more items of content from the content library further includes: downloading, from the content library, two or more items of multimedia content; updating a first display screen associated with a first display identifier to display a first multimedia content associated with a first content identifier; and updating a second display screen associated with a second display identifier to display a second multimedia content associated with a second content identifier.

In some aspects, the techniques described herein relate to a computer system including: a display cube device configured to: detect an angle of rotation of a plurality of peripheral pieces including an exterior face of the display cube device; encode rotational data including the angle of rotation and an axis of rotation; and update content displayed in a graphical user interface of two or more display screens of the display cube device responsive to a control signal; wherein a first display screen is centered on a first axis of the display cube device and a second display screen is centered on a second axis of the display cube device such that a subset of the plurality of peripheral pieces disposed adjacent to the first display screen and the second display screen are rotatable about the first axis and the second axis; and a client device configured to: receive, from the display cube device, encoded rotational data; determine, based on the angle of rotation and the axis of rotation, updated display content for display in the graphical user interface of the two or more display screens; generate one or more control signals to cause the display cube device to display the updated display content in an updated graphical user interface; and transmit the one or more control signals to the display cube device.

In some aspects, the techniques described herein relate to a computer system, wherein the client device is another display cube device.

In some aspects, the techniques described herein relate to a computer system, wherein the client device is communicatively connected to the display cube device and a platform server device hosting a content library.

In some aspects, the techniques described herein relate to a computer system, wherein the client device executes a cube device application to cause the client device to access the content library via a network and serve the updated display content to the display cube device.

In some aspects, the techniques described herein relate to a computer system, wherein the client device is communicatively connected to a plurality of display cube devices, and wherein the cube device application is configured to generate data-driven insights based on usage data of each display cube device.

In some aspects, the techniques described herein relate to a computer system, wherein the data-driven insights include response statistics, timing data, and scoring or grading data for a plurality of users of the plurality of display cube devices.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 depicts a networked computing environment for operation of a programmable display cube device, according to one embodiment.

FIG. 2 depicts an example computer system suitable for use in the networked computing environment of FIG. 1, according to one embodiment.

FIGS. 3A-3C depict the programmable display cube device of FIG. 1, according to one embodiment.

FIGS. 4A-4C depict the programmable display cube device of FIG. 1, according to an additional embodiment.

FIGS. 4D-4M depict various components of the display cube device of FIG. 4A, according to one embodiment.

FIGS. 4N and 4O depict a cross-section of the display cube device of FIG. 4A, according to one embodiment.

FIG. 5A depicts a graphical user interface for display of multimedia content by the programmable display cube device of any of the previous figures, according to one embodiment.

FIG. 5B depicts a graphical user interface for display of multimedia content by the programmable display cube device of any of the previous figures, according to an additional embodiment.

FIG. 6 depicts a logical map for updating the graphical user interfaces of FIG. 5A or 5B, according to one embodiment.

FIG. 7 depicts steps of a method for dynamically updating display content by the programmable display cube device of any of the previous figures, in accordance with one embodiment.

FIG. 8 depicts a timing diagram illustrating a method for responding to user input by the programmable display cube device of any of the previous figures, according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A reference to the numeral alone generally refers to any one or any combination of such elements, unless the context indicates otherwise. The figures depict embodiments of the disclosed device (or method) for purposes of illustration only. One skilled in the art will readily recognize from the following description that alternative embodiments of the structures and methods illustrated herein may be employed without departing from the principles described herein.

### Example Networked Computing Environment

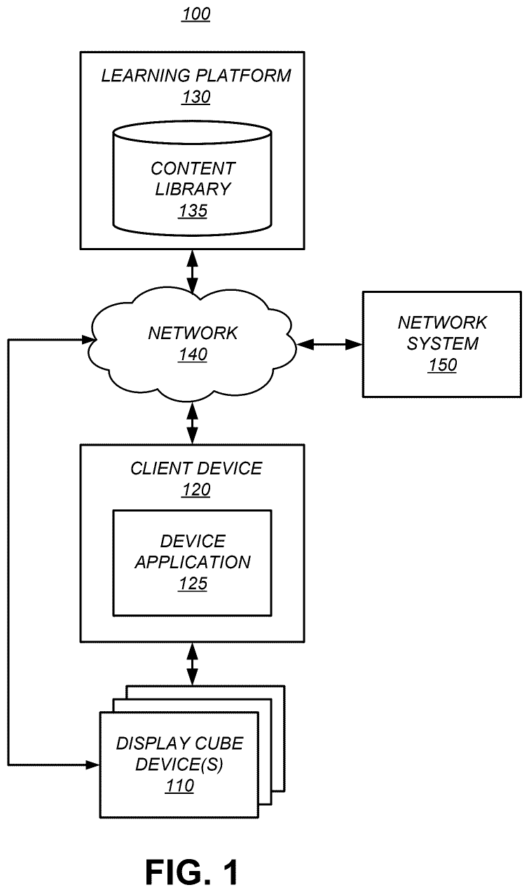

FIG. 1 is a conceptual diagram of a networked computing environment 100 in which one or more programmable display cube devices 110 operate, according to one embodiment. In the configuration illustrated by FIG. 1, the computing environment 100 includes a plurality of display cube devices 110 coupled (e.g., paired) to at least one client device 120 running a cube device application 125. The client device 120 may be a mobile device (e.g., a tablet, smartphone, notebook computer, or similar) but can include any type of computing device communicatively connected to a display cube device 110, including additional display cube devices 110. The client device 120 may connect to one or more of the display cube devices 110 by way of Bluetooth, Wi-Fi, near-field communication (NFC), ultra-wideband (UWB), or any other wireless technology. In an embodiment, two or more of the plurality of display cube devices 110 may be connected in a mesh network or partial mesh network (e.g., a peer-to-peer network) configuration. In other embodiments, a plurality of display cube devices 110 may be paired to a single client device 120 which executes the cube device application 125. In a classroom setting, this can facilitate distribution of educational content from a teacher's mobile device (e.g., the client device 120) to a plurality of student display cube devices 110, as will be discussed in greater detail herein. In an additional embodiment, the computing environment 100 may be provided with a plurality of client devices 120 each paired to one or more cube devices of a plurality of cube devices 110.

As illustrated, the client device 120 is connected to a learning platform 130 (also referred to as an online learning platform, learning management platform, education platform, or platform server device) via a network 140 operated by a network system 150. The learning platform 130 may be, for example, a cloud learning platform accessible to the client device 120 over a wide area network (WAN, such as the internet) or a locally hosted platform accessible over a local area network (LAN). The learning platform 130 includes a content library 135 (e.g., a database) for storing multimedia content (e.g., text, images, videos, and/or audio content) related to one or more programs (e.g., educational programs which implement a lesson plan) as prescribed by a user (e.g., an education professional). In some cases, the content library 135 is hosted separately from the learning platform 130 (e.g., on a remote server communicatively connected to the learning platform 130 via the network 140).

In general, communication between the network system 150 and a client device 120 is carried out via a network interface using any type of wired or wireless connection, using a variety of communication protocols (e.g., TCP/IP, HTTP, S1v1TP, FTP), encodings or formats (e.g., HTML, JSON, XML), or protection schemes (e.g., VPN, secure HTTP, SSL). The network system 150 may include one or more servers that provide application functionality to the client device 120 and content for display on the cube device(s) 110. Modules of the network system 150 may be responsible for registering cube devices 110 and client devices 120, pairing devices (e.g., pairing a teacher's mobile device to one or more cube devices 110 associated with one or more students), providing content for display on cube devices 110, and tracking responses to content from users of the cube devices 110. In various embodiments, the network system 150 integrates artificial intelligence technologies to provide personalized learning experiences to users, analyze data on user performance and provide tailored support, and automate tasks typically performed by users of the cube device application 125 (e.g., teachers), such as grading assignments or quizzes.

The learning platform 130 is configured to serve multimedia content to the client device 120 and/or display cube device 110 when requested. In certain embodiments, the client device 120 may receive multimedia content from the learning platform 130 and relay the content to the display cube device 110 responsive to rotational inputs by a user of the cube device 110. As will be discussed herein, in various embodiments, the client device 120 may behave as an intermediary between the display cube device 110 and the learning platform 130 to identify and provide updated multimedia content for display by the device 110 in accordance with user inputs. The client device 120 may implement data recording and analysis functionality for generating data-driven insights about users' educational progress. In certain embodiments, the display cube device 110 operates independently of the client device 120 by directly accessing the content library 135 via the network 140. The display cube device 110 may also access content from local storage (e.g., cached content saved in memory, or content provided on a removable storage device).

In various embodiments, the content library 135 contains questions or prompts on a plurality of topics and in a variety of formats, as discussed herein. Content may be organized by topic, question type, difficulty/grade level, or other factors and can optionally designate a content source, such as an indication that a content item originates with the network system 150 or was provided by another user, such as a teacher or expert in the relevant field. In some embodiments, where content is supplied by a user of the network system 150, the network system 150 reviews the content (e.g., the question(s) and response(s)) before publishing the content for use by other users. For example, a question and answer may be reviewed for accuracy, for appropriate topical/difficulty level classifications, etc.

In various embodiments, the content library 135 also stores (1) associations of cube devices 110 with one or more cube device applications 125; (2) user profiles of users associated with cube devices 110, such as student profiles that track a student's progress in a plurality of subjects; (3) user profiles of users associated with cube device applications 125, such as teacher profiles that track subjects the teacher is actively teaching, data regarding questions, prompts, or other material provided to cube devices 110 associated with the cube device application 125, statistical data regarding student responses, prompts or questions supplied by the teacher to the network system 150 (e.g., for use by the teacher and, optionally, one or more other users of the cube device application 125), and the like.

The content library 135 may also store data regarding available software and hardware updates. In one embodiment, the network system 150 provides hardware and onboard software updates to the cube devices 110 and software updates for the cube device application 125 to the client device 120 in response to user input. Alternatively, hardware and software updates are provided automatically upon the network system 150 identifying an available update.

### Example Computing Machine Architecture

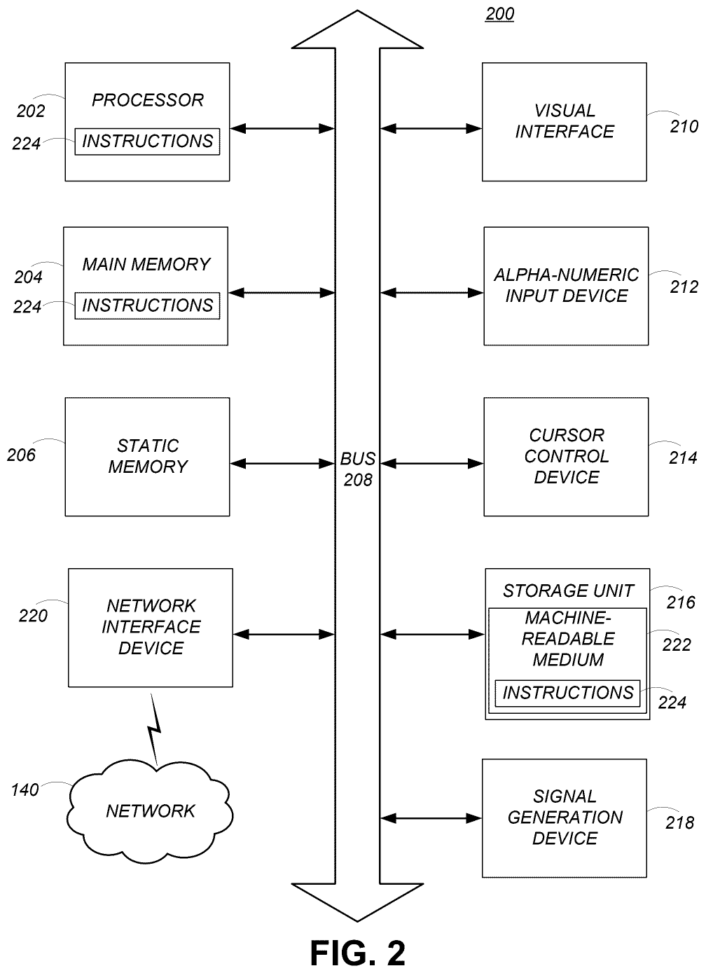

FIG. 2 is a block diagram illustrating components of an example machine able to read instructions from a machine-readable medium and execute them in a processor (or controller), such as the programmable display cube device 110 or the client device 120 of FIG. 1. Specifically, FIG. 2 shows a diagrammatic representation of a machine in the example form of a computer system 200 within which program code (e.g., software, such as the cube device application 125) for causing the machine to perform any one or more of the methodologies discussed herein may be executed. The program code may be comprised of instructions 224 executable by one or more processors 202. In various embodiments, the machine operates as a standalone device or may be connected (e.g., networked via the network 140) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein, such as those of the networked computing environment 100 of FIG. 1.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. The computer system 200 may further include a visual display interface 210 (also referred to as a display screen 210). The visual display interface 210 may include a software driver that enables displaying one or more user interfaces on one or more screens (or displays). The visual display interface 210 may display user interfaces directly (e.g., on the screen) or indirectly on a surface, window, or the like (e.g., via a visual projection unit). For ease of discussion, the visual display interface 210 may be described as a display screen or a display panel. The visual display interface 210 may include or may interface with a touch-enabled screen. The computer system 200 may also include an alphanumeric input device 212 (e.g., a keyboard or touch screen keyboard), a cursor control device 214 (e.g., a mouse, a trackball, a joystick, a motion sensor, a rotational input, or another directional input), a storage unit 216, a signal generation device 218 (e.g., a speaker, vibration motor, or a combination thereof), and a network interface device 220, which also are configured to communicate via the bus 208.

The storage unit 216 includes a machine-readable medium 222 on which is stored instructions 224 (e.g., software) embodying any one or more of the methodologies or functions described herein. The storage unit 216 may be a removable storage device (e.g., an SD card or similar) which is interchangeable with other removable storage devices. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over the network 140 via the network interface device 220. The network interface device 220 can provide wireless connectivity via one or more network protocols such as TCP/IP, UDP, FTP, Bluetooth, Zigbee, LTE, and the like. The network interface device 220 may include a radio frequency (RF) module capable of communicating with one or more external devices (e.g., the client device 120) via one or more RF bands. In some instances, the network interface device 220 supports multiple-input, multiple-output (MIMO) or spread spectrum communications for high data throughput.

While the machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Example Programmable Display Cube Device

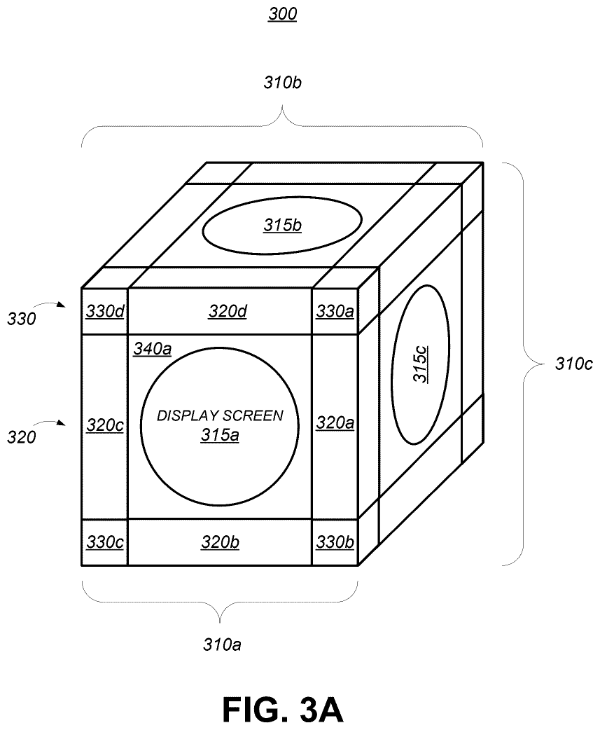

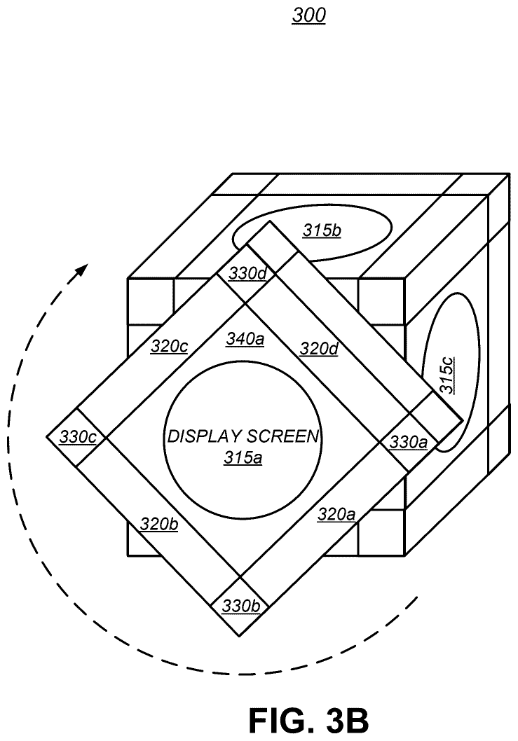

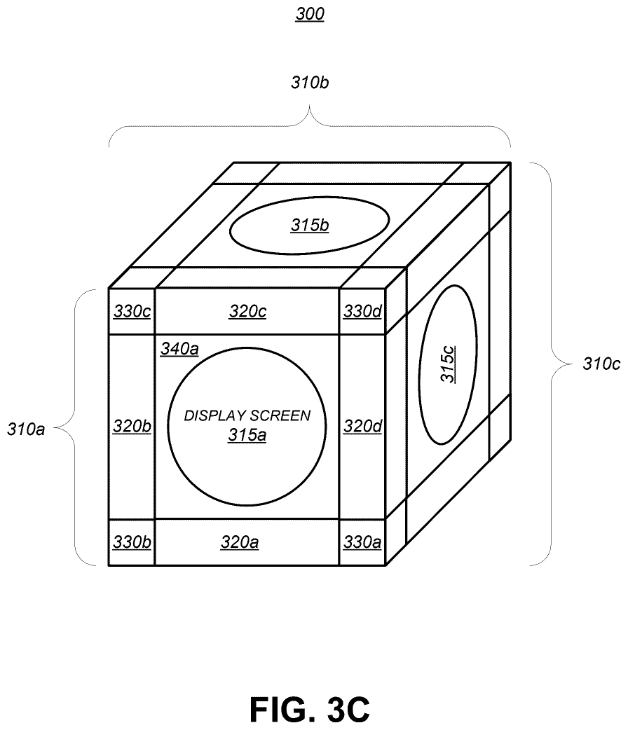

FIGS. 3A-3C are schematic representations of the programmable display cube device 110 of FIG. 1, according to one embodiment. A programmable display cube device 300 is a programmable electronic device capable of manipulation by a user to change a configuration of data displayed on one or more exterior faces 310 of the device 300. From the perspective of FIG. 3A, a front face 310a, a top face 310b, and a right-side face 310c of the display cube device 300 are visible. In the illustrated embodiment, the display cube device 300 is in a “3×3×3” configuration characterized by the 3 rows and 3 columns which comprise each face, although various configurations (such as a 5×5×5 or 7×7×7 cube) are also possible.

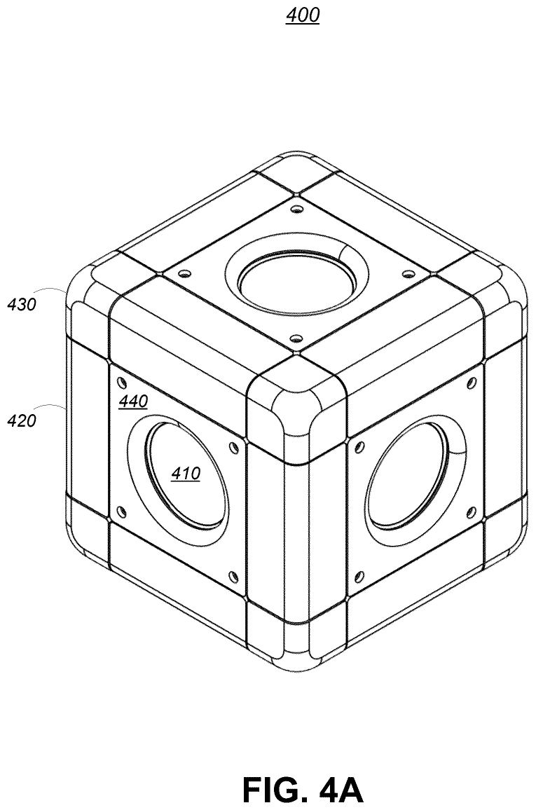

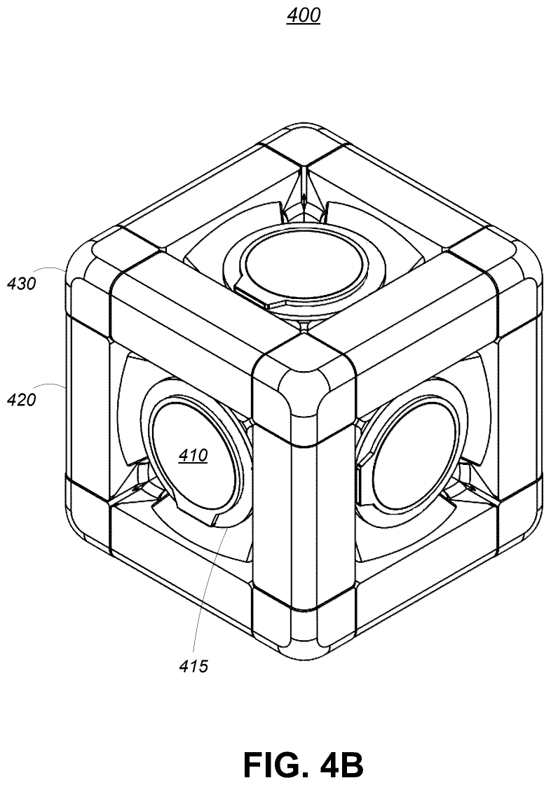

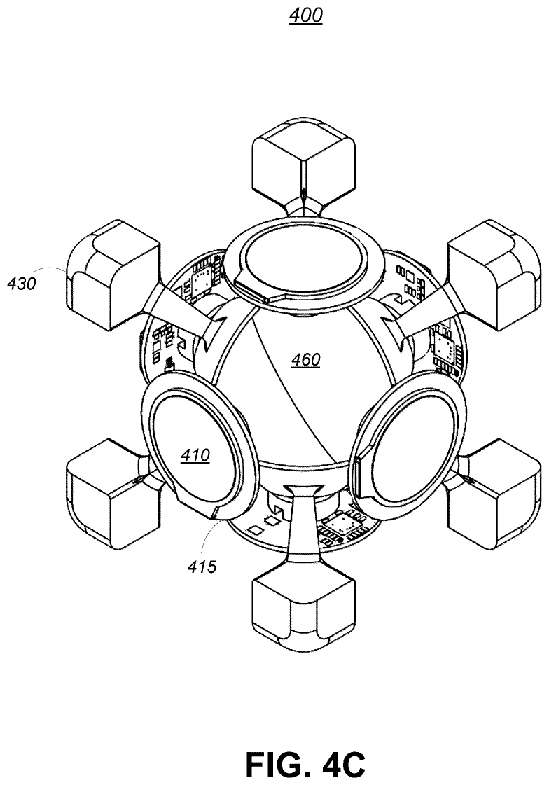

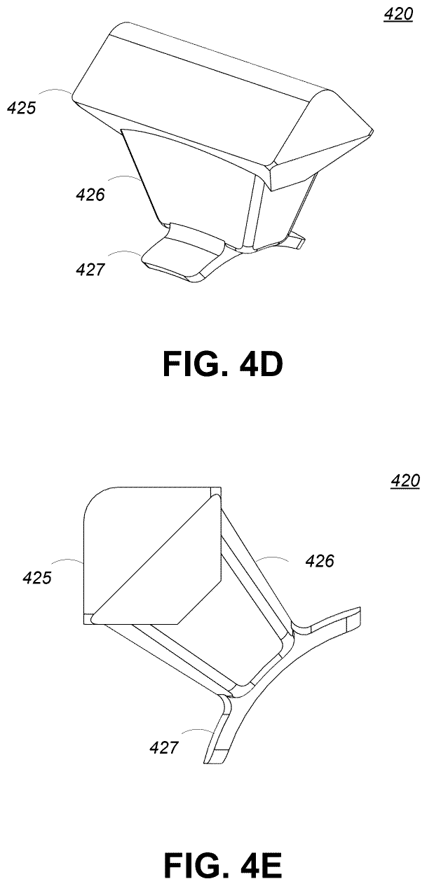

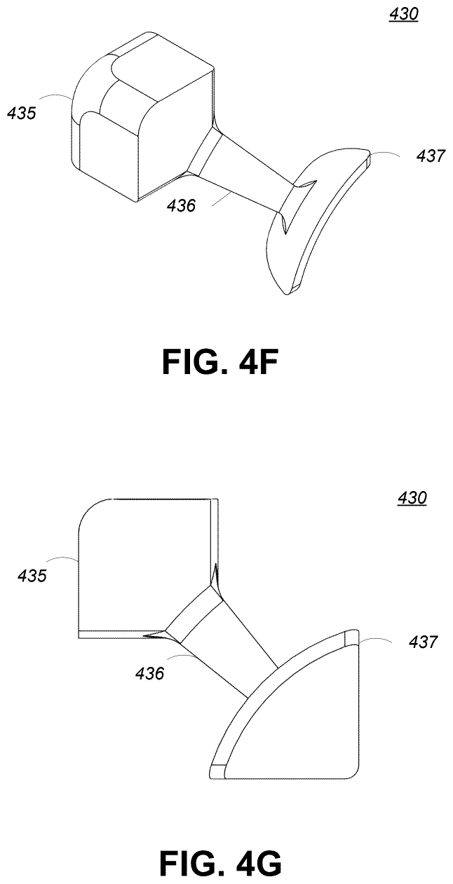

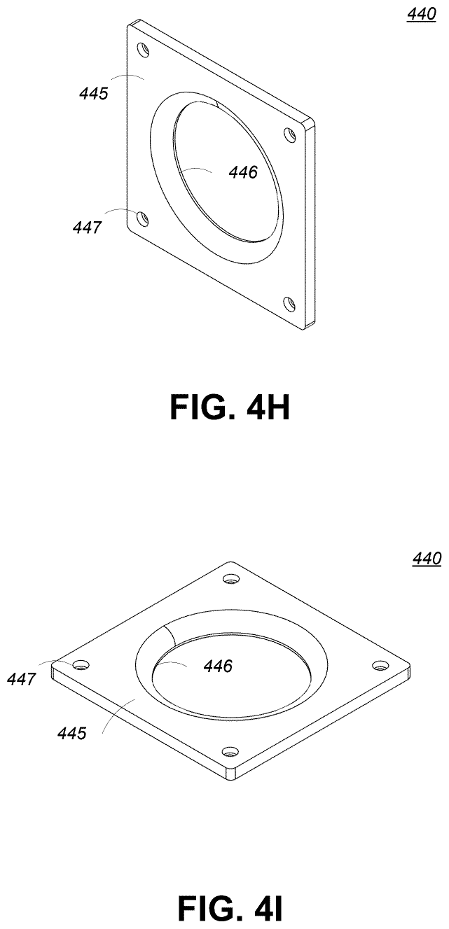

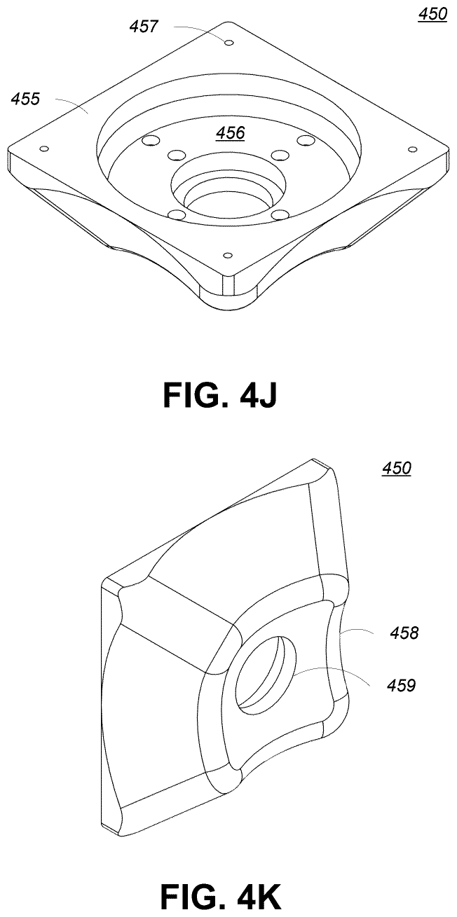

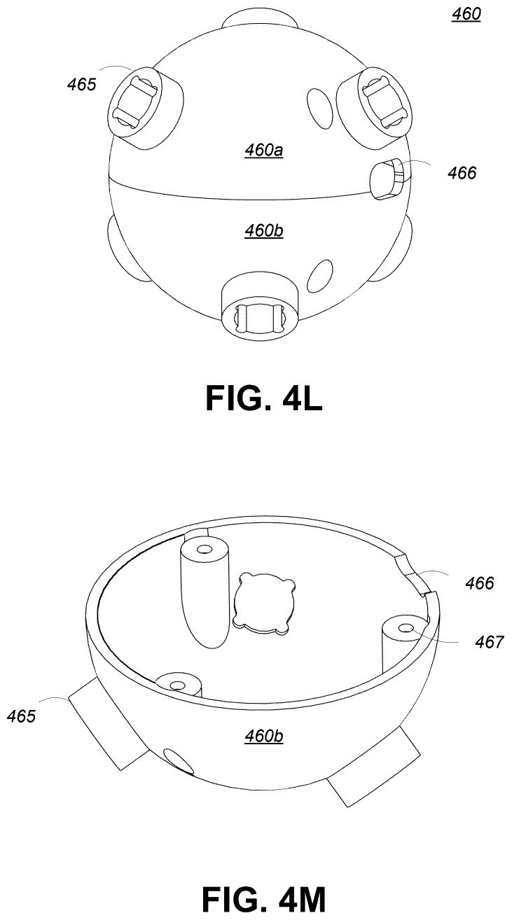

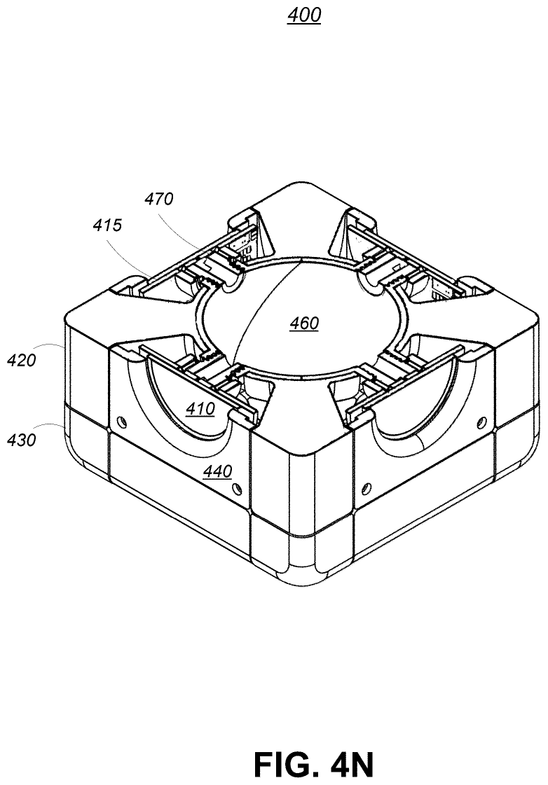

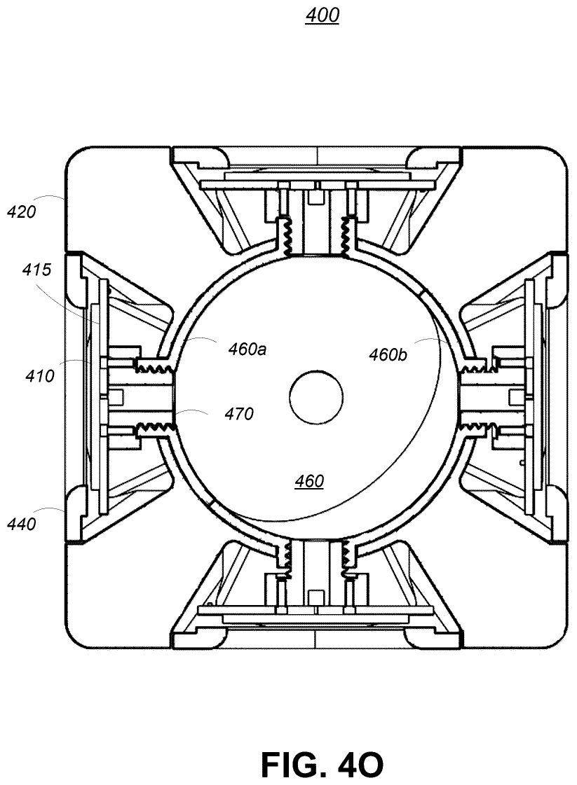

The rows and columns of each exterior face are made up of a plurality of peripheral pieces disposed around a center piece (discussed below with reference to FIGS. 4C and 4L-4O) which give the display cube device 300 a substantially cubelike structure. In the 3×3×3 embodiment of FIG. 3A, the visible faces of the display cube device 300 include a total of twelve edge pieces 320 and eight corner pieces 330. In various embodiments, the display cube device 300 includes additional peripheral pieces forming additional rows and columns of each exterior face. A corner piece 330 has three orthogonal faces which meet at a corner of three exterior faces of the display cube device 300, and an edge piece 320 has two orthogonal faces which meet along an edge of two exterior faces of the display cube device 300. Each orthogonal face of a peripheral piece makes up a peripheral portion of an exterior face 310 of the display cube device 300. For example, a first corner piece 330a of FIG. 3A, located in an upper-right corner of the front face 310a, makes up a peripheral portion of the front face 310a, the top face 310b, and the right-side face 310c. Likewise, a first edge piece 320a of FIG. 3A, located along a right-side edge of the front face 310a, makes up a peripheral portion of the front face 310a and the right-side face 310c.

Display screens (e.g., the visual interface 210), also referred to hereafter as display panels 315, are disposed in a central region of one or more of the faces 310 of the display cube device 300. A display panel 315 may be constructed according to any display panel technology known to those skilled in the art including, for example, a liquid crystal display (LCD), organic light-emitting diode (OLED) display, e-paper display (or other bistable display), or similar. The display panel 315 is provided in a central region of an exterior face 310 of the display cube device 300. The display panel 315 may be centered on a first axis extending from the center piece of the display cube device 300 such that a subset of the plurality of peripheral pieces comprising a peripheral portion of the exterior face 310 is configured to rotate about the display panel 315 and the first axis. The subset of the plurality of peripheral pieces may be further configured to rotate about an additional display panel 315 centered on a second axis extending from the center piece of the display cube device 300, as will be discussed herein.

Each display panel 315 is configured to display multimedia content accessed from the content library 135 (e.g., via a client device 120 paired to the display cube device 300) or directly from memory (e.g., the storage unit 216). In certain embodiments, one display panel (e.g., a front display panel 315a) of a plurality of display panels 315 is designated the “primary” or “main” display on which primary content, such as a question or prompt, is displayed to a user. Secondary content, such as complete or partial answers to the question or prompt, may be displayed on one or more additional display panels (e.g., a top display panel 315b or right-side display panel 315c) of the plurality of display panels 315. In certain embodiments, the display cube device 300 identifies the primary or main display panel 315 based on gyroscopic data, acceleration data, external tracking data, user input data, or a combination thereof to determine a relative orientation of the display cube device 300.

In the example of FIG. 3A, each display panel 315 is substantially circular, and each face 310 of the display cube device 300 includes a face plate 340 which is provided in the central region between the display panel 315 and the plurality of peripheral pieces. Each face plate 340 retains one of the display panels 315 within the cube structure of the display cube device 300, providing an illusion that the plurality of peripheral pieces and the display panel 315 make up a uniform exterior face 310. A display panel 315 may be provided within an opening in the face plate 340 (e.g., to provide a smooth, uniform appearance of the exterior face 310) or the display panel 315 may be recessed behind the opening (e.g., to protect the display panel 315 from damage). As will be discussed herein, display panels 315 may be of various sizes and shapes, necessitating various configurations the face plates 340. In one embodiment, a display panel 315 (e.g., a square display panel) may occupy the entire central region of an exterior face 310, so a face plate 340 is not provided.

The plurality of peripheral pieces is configured to rotate about two or more axes of the display cube device 300 extending from a center piece. Specifically, a subset of four edge pieces (e.g., the edge pieces 320a-320d) and four corner pieces (e.g., the corner pieces 330a-330d), which comprise a periphery of one exterior face 310 of the device 300 (e.g., the front face 310a), are rotatable about a first axis (e.g., an x-axis) associated with a first exterior face (e.g., the front face 310a). In the example of FIG. 3B, the eight peripheral pieces of the front face 310a are rotated clockwise about the first axis. FIG. 3C illustrates the display cube device 300 after clockwise rotation of the eight peripheral pieces of the front face 310a, indicating how the subset of four edge pieces (e.g., the edge pieces 320a-320d) and four corner pieces (e.g., the corner pieces 330a-330d), have been repositioned with respect to the top face 310b and right-side face 310c. Additionally or alternatively, the eight peripheral pieces of the front face 310a may rotate about a second axis or a third axis (e.g., a y-axis or a z-axis) associated with a second exterior face or a third exterior face (e.g., the top face 310b or right-side face 310c).

The display panel 315a and associated face plate 340a may rotate in cooperation with the subset of the plurality of peripheral pieces, providing the appearance of the front exterior face 310a rotating as a whole. Notably, one advantage of a circular display panel 315 (such as the front display panel 315a) is that the display panel 315 can remain stationary in the center region of the exterior face 310 while the subset of the plurality of peripheral pieces and the face plate 340 rotate freely. A graphical user interface (GUI) displaying content on the display panel 315 can be updated in software (e.g., by rotating the content 90, 180, or 270 degrees) to adjust the output of the display panel 315 accordingly.

FIGS. 4A-4C are schematic representations of the programmable display cube device 110 of FIG. 1, in accordance with an additional embodiment. A programmable display cube device 400 includes a display panel 410 (e.g., the display screen 210), an edge piece 420 (e.g., the edge pieces 320), a corner piece 430 (e.g., the corner pieces 330), and a face plate 440 (e.g., the face plates 340). A plurality of edge pieces 420 and a plurality of corner pieces 430 (collectively referred to as the plurality of peripheral pieces) form a cube structure of the programmable display cube device 400, including six rotatable exterior faces.

The display panel 410 is mounted to a printed circuit board (PCB) 415 which abuts the face plate 440. The PCB 415 is electronically coupled to a computing device (e.g., the computer system 200) and is configured to receive multimedia content from the computing device for display by the display panel 410. Although the PCB 415 is illustrated as having a footprint which extends substantially beyond that of the display panel 410, in certain embodiments, the display panel 410 extends to the edges of the PCB 415, or the PCB 415 is integrated fully within the display panel 410.

In the example of FIGS. 4B-4C, the display panel 410 is a circular display panel having a corresponding circular PCB 415. In other examples, the display panel 410 is a substantially rectangular display panel, such as rectangular panel with rounded corners. The footprint of the PCB 415 may differ from that of the display panel 410. In an embodiment, the PCB 415 may include a plurality of PCB layers. In some cases, the PCB 415 may be a flexible or folding PCB. In various embodiments, the display panel 410 and the PCB 415 are fixedly or rotatably mounted to a center piece 460, the display panel 410 being provided in a central region of one exterior face of the programmable display cube device 400.

The center piece 460 is a hollow, substantially spherical structure about which the plurality of peripheral pieces is disposed. The center piece 460 is aligned with three rotational axes of the programmable display cube device 400. A subset of the plurality of peripheral pieces which comprise one exterior face of the programmable display cube device 400 freely rotate about a corresponding axis by sliding along a spherical outer surface of the center piece 460. The center piece 460 may be constructed from a pair of hemispheres (e.g., halves of a spherical shell) fixedly connected to each other.

The center piece 460 houses the computing device, including components of the computer system 200 as described above with reference to FIG. 2. In one embodiment, the center piece 460 contains a microprocessor (e.g., the processor 202), a power source (e.g., a battery, supercapacitor, charging circuit, or similar), a removable storage device (e.g., the storage unit 216), and a communications module (e.g., the network interface device 220 or another RF module). The computing device outputs multimedia content for display in a GUI of each display screen 410 via the microprocessor. For example, the computing device may output (e.g., update, refresh, or otherwise modify) display content and/or audio content responsive to user input detected via rotation of a subset of the plurality of peripheral pieces, or in response to instructions received from a connected client device 120. Two or more display panels 410 may be individually addressable, allowing the microprocessor to update specific display content on each panel 410 in accordance with a combination of user inputs. In some embodiments, the center piece 460 includes, or is communicatively connected to, one or more sensors (e.g., a gyroscope, accelerometer, or rotary encoder) for sensing rotational inputs associated with the six exterior faces of the display cube device 400.

FIGS. 4D-4E are schematic representations of an exemplary edge piece 420 of the programmable display cube device 400 of FIGS. 4A-4C. The edge piece 420 includes a distal end 425 having two orthogonal faces, each orthogonal face forming an edge portion (e.g., a periphery) of one exterior face of the programmable display cube device 400. In the illustrated embodiment, the two orthogonal faces share a rounded edge to provide better ergonomics for handling the programmable display cube device 400. In various embodiments, one or more edges of the programmable display cube device 400 may be chamfered, filleted, beveled, or otherwise smoothed.

An intermediate portion 426 (e.g., a projection or stem) of the edge piece 420 extends from the distal end 425 to a proximal end 427. The proximal end 427 is configured to mechanically interface with the center piece 460 by sliding along the spherical outer surface as the user rotates an exterior face of the programmable display cube device 400. The proximal end 427 has a curvature which matches a curvature of the center piece 460 and may include a pair of outward-facing curved projections to support the edge piece 420 against the center piece 460. In certain embodiments, the distal end 425 or proximal end 427 includes a magnet. The magnet may be attracted to one or more magnets in the center piece 460 or an adjacent peripheral piece and may be configured to resist rotation by the user.

FIGS. 4F-4G are schematic representations of an exemplary corner piece 430 of the programmable display cube device 400 of FIGS. 4A-4C. Those skilled in the art will appreciate that the corner piece 430 is functionally similar to the edge piece 420 discussed above with reference to FIGS. 4D-4E. The corner piece 430 includes a distal end 435 having three orthogonal faces, each orthogonal face forming a corner portion (e.g., a periphery) of one exterior face of the programmable display cube device 400. In the illustrated example, the three orthogonal faces are connected by rounded edges, including a rounded corner. The rounded edges and rounded corner may help to protect the device 400 from damage caused by, e.g., dropping or throwing the programmable display cube device 400. In various embodiments, the distal end 435 is padded or formed from an elastic material, which can enhance user safety and durability of the programmable display cube device 400.

An intermediate portion 436 (e.g., a projection or stem) of the corner piece 430 extends from the distal end 435 to a proximal end 437. The proximal end 437 is configured to mechanically interface with the center piece 460 by sliding along the spherical outer surface as the user rotates a face of the programmable display cube device 400. The proximal end 437 has a curvature which matches a curvature of the center piece 460 and may include one or more curved projections to support the corner piece 430 against the center piece 460. In certain embodiments, the distal end 435 or proximal end 437 includes a magnet. The magnet may be attracted to one or more magnets in the center piece 460 or an adjacent peripheral piece and may be configured to resist rotation by the user.

In an example, the user may rotate a first exterior face of the programmable display cube device 400 (e.g., a first subset of the plurality of peripheral pieces) about a first axis and rotate a second exterior face of the programmable display cube device 400 (e.g., a second subset of the plurality of peripheral pieces) about a second axis. Rotation of the first exterior face may reorient four edge pieces 420 and four corner pieces 430 of the first subset of peripheral pieces. Rotation of the second exterior face may reorient four edge pieces 420 and four corner pieces 430 of the second subset of peripheral pieces on the spherical outer surface of the center piece 460. Notably, rotation of the first exterior face followed by rotation of the second exterior face may result in rotation of one or more shared peripheral pieces (e.g., a subset of edge pieces 420 and/or corner pieces 430 common to both exterior faces) about both the first axis and the second axis. The user may therefore rotate any of the six exterior faces about one of the three central axes of the programmable display cube device 400 to reorient the plurality of peripheral pieces (e.g., responsive to content displayed in the GUI of one or more display panels 410).

FIGS. 4H-4I are schematic representations of an exemplary face plate 440 of the programmable display cube device 400 of FIG. 4A. FIGS. 4J-4K are schematic representations of an exemplary support piece 450 for mounting the face plate 440.

The face plate 440 includes a planar exterior surface 445 which makes up a portion of one exterior face of the programmable display cube device 400. In various embodiments, the face plate 440 has a rectangular (e.g., square) or circular profile which occupies a central region of the exterior face. The face plate 440 extends between the plurality of peripheral pieces (e.g., edge pieces 420 and corner pieces 430) which form the perimeter (e.g., a peripheral region) of the exterior face. The face plate 440 protects the programmable display cube device 400 by preventing foreign objects (such dust particles, or the user's fingers) from entering the sliding mechanisms. In the illustrated embodiment, the face plate 440 includes a display opening 446 configured to house the circular display panel 410 as seen in FIG. 4A. The display opening 446 may have a rounded or chamfered edge. The face plate 440 may include a plurality of screw holes 447 for fixedly mounting the face plate 440 to a support piece 450.

The support piece 450 is a structural component of the programmable display cube device 400 which supports the face plate 440 on the exterior face of the programmable display cube device 400. The support piece 450 has a planar face 455 including a cavity 456 and a plurality of screw holes 457 for fixedly mounting the face plate 440 to the planar face 455. In the illustrated embodiment, the cavity 456 is a circular cavity configured to house the circular PCB 415 of FIGS. 4B-4C. Advantageously, the circular cavity 456 allows the support piece 450 and face plate 440 to rotate freely alongside the plurality of peripheral pieces while the PCB 415 and display panel 410 remain fixedly mounted to the center piece 460.

A reverse face 458 of the support piece 450 has a curvature matching the curvature of the spherical center piece 460. At the center of the reverse face 458 is a through-hole 459 for rotatably mounting the support piece 450 to the center piece 460. The through-hole 459 allows for electrical connections (e.g., power and data transfer) between the PCB 415 and the computing device within the center piece 460. As the user rotates a plurality of peripheral pieces of an exterior face of the programmable display cube device 400, the face plate 440 and support piece 450 rotate together with the peripheral pieces, maintaining an illusion that the exterior face is a contiguous piece.

FIG. 4L is a perspective view of the center piece 460 of FIG. 4C. The center piece 460 is substantially a sphere with a plurality of projections 465 extending radially outward, each projection 465 corresponding to a rotational axis of one exterior face of the programmable display cube device 400. The center piece 460 contains the computing device (e.g., the computer system 200) which is responsible for receiving multimedia content (e.g., from the client device 120 via the cube device application 125 or from the learning platform 130 via an application programming interface) and updating the graphical user interface of each display panel 410. A PCB 415 and display panel 410 may be fixedly mounted to an end of each projection 465 and connected to the computing device through an opening in the projection 465. In certain embodiments, the projection 465 is threaded to allow a PCB mount (discussed below with reference to FIGS. 4N-4O) to be screwed into the projection 465. In the illustrated embodiment, the opening of each projection 465 is keyed to prevent rotation of the PCB 415 and PCB mount. The center piece 460 may include additional openings to facilitate power and/or data transfer by the computing device, such as a charging port opening 466. The charging port opening 466 may be provided with a charging port which electronically interfaces with charging circuitry inside the center piece 460 and is configured to receive a power connector (e.g., a USB Type-C connector or similar). The charging port may also support data transfer for programming the display cube device 110 (e.g., to apply software updates). In certain embodiments, the charging circuitry may further include hardware to support one or more wireless charging technologies.

For ease of manufacture, the spherical center piece 460 may be assembled by combining an upper hemisphere piece 460a and a lower hemisphere piece 460b. In certain embodiments, the upper hemisphere piece 460a and the lower hemisphere piece 460b may be substantially the same. FIG. 4M is a perspective view of an exemplary lower hemisphere piece 460b of the center piece 460. To assemble the center piece 460, the computing device may be provided inside a hollow body of the lower hemisphere piece 460b, and the upper hemisphere piece 460a may be attached to the lower hemisphere 460b by driving screws through a plurality of matching screw holes 467. In various embodiments, glue or another adhesive may be used to bond the upper hemisphere piece 460a and the lower hemisphere piece 460b.

FIGS. 4N and 4O are cross-sectional representations of the programmable display cube device 400 according to any of the previous embodiments. Each projection 465 of the center piece 460 is connected to a corresponding PCB 415 by way of a threaded PCB mount 470. The face plate 440 is supported against the display panel 410 by a corresponding support piece 450 (not shown). From the perspective of FIG. 4O, four edge pieces 420 are located along opposite sides of the center piece 460 and retained against the center piece by support pieces 450. In various embodiments, the programmable display cube device 400 may include more or fewer display panels 410 or more or fewer edge pieces 420. Those skilled in the art will envision additional embodiments of the programmable display cube device 400 falling within the scope of the present disclosure.

### Example User Interfaces of a Programmable Display Cube Device

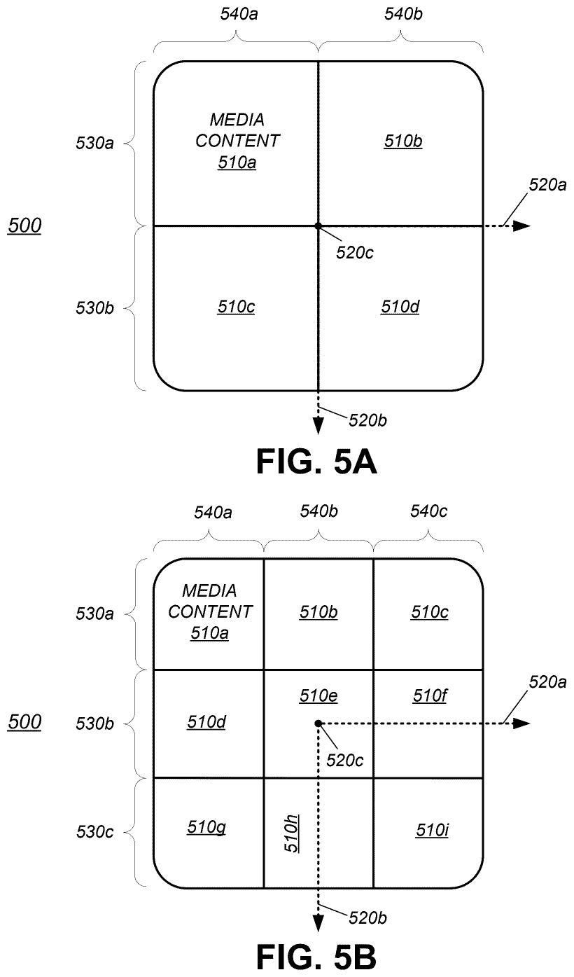

FIG. 5A is a schematic representation of a graphical user interface for display of multimedia content by a programmable display cube device of any of the previous figures, according to one embodiment. FIG. 5B is a schematic representation of the graphical user interface of FIG. 5A in accordance with an additional embodiment. It will be understood that, although the graphical user interface 500 is depicted in a generally square format, the embodiments discussed herein may be readily adapted to the circular display panel 410 of any of FIGS. 4A-4O. In some instances, the graphical user interface 500 occupies a portion of a display panel (e.g., a display window) which may be dynamically re-sized or scaled based on display content.

The graphical user interface 500 (GUI hereinafter) is generated and/or updated to display multimedia content to the user based on current or past rotational inputs to a display cube device 110 (e.g., the programmable display cube device 300 or 400). In various embodiments, the GUI 500 may be generated and updated by the computing device (e.g., the computer system 200) and/or the client device 120. In one embodiment, the computer system 200 may download multimedia content from the content library 135 (e.g., by an application programming interface) to generate an updated GUI 500. In another embodiment, the client device 120 may download multimedia content from the content library 135, generate an updated GUI 500 in accordance with input signals, and transmit the updated GUI 500 to the computer system 200 display by the display cube device 110. The input signals may be analog or digital signals indicative of one or more rotational inputs by a user of the display cube device 110. As will be discussed herein, certain combinations of input signals may trigger a corresponding function in the GUI 500.

The GUI 500 is generally divided into rows and columns. In the example of FIG. 5A, the GUI 500 is divided into quadrants for displaying up to four items of multimedia content 510a-510d in a side-by-side configuration. The GUI 500 of FIG. 5B extends this concept, displaying up to nine items of multimedia content 510a-510i in a rectangular grid. Each item of multimedia content 510 is located in a row (e.g., one of the rows 530a-530c) and a column (e.g., one of the columns 540a-540c) of the GUI 500.

It will be readily understood how the rows 530 and columns 540 of the GUI 500 may be mapped to rotational inputs of the rows and columns of each exterior face of the programmable display cube device 110. For example, by rotating a top face (e.g., the top face 310b of the display cube device 300), the user may cause the GUI 500 to update multimedia content 510 displayed in a top row 530a accordingly. Updating multimedia content 510 can include downloading new multimedia content 510 or “moving” displayed multimedia content between two or more display screens 210 (e.g., replacing content displayed in a GUI of a first display screen with content previously displayed in a GUI of a second display screen).

The computer system 200 or client device 120 may identify, based on rotational input signals, an axis of rotation (e.g., a first axis 520a, a second axis 520b, and/or a third axis 520c) and a direction of rotation (e.g., clockwise or counterclockwise) in order to determine specific display screen(s) 210 and GUI(s) 500 having multimedia content 510 in need of updating. The rotational input signals may further include angular rotation data (e.g., a number of degrees of rotation) used to animate the GUI 500 while the user is rotating an exterior face of the display cube device 110. In an example, animating the GUI 500 may include displaying a preview of multimedia content 510 to be updated should the user complete a full (e.g., 90, 180, or 270-degree) rotation of the exterior face of the display cube device 110.

In certain embodiments, the rows 530 and columns 540 (or other elements of the GUI 500) may be adjusted, scaled, re-sized, or similar. For example, the number of rows 530 and the number of columns 540 of the GUI 500 may change based on the number of items of multimedia content 510 to be displayed. The GUI 500 may transition between the embodiment of FIG. 5A and the embodiment of FIG. 5B when, for example, the cube device application 125 or another software application (e.g., an educational program prescribed by an education professional) downloads additional content 510 from the content library 135 for display in the GUI 500.

In an example, the software application may be a matching puzzle executed by the computer system 200. In the case of a matching puzzle application, the GUI 500 may be divided into an upper half (e.g., the first row 530a) and a lower half (e.g., a second row 530b) having only a single column 540a. The object of the puzzle is for the user to rotate top and bottom exterior faces of the cube device 110 until two related items of multimedia content 510 are displayed adjacent to each other (e.g., matched) in the GUI 500. As the user solves the puzzle, the software application may determine that the current puzzle mode is too easy and can adjust the GUI 500 to add additional rows 530 and columns 540 to present a challenge based on the user's skill level. The matching puzzle application is an example of a software application with broad applications in STEM and language education. The multimedia content 510 may include text, images, motion graphics, and/or audio outputs of the programmable display cube device 110.

The display cube device 110 operates in an active mode as described above in which the user manipulates the device 110 by changing the positions of the peripheral pieces relative to each other (e.g., by rotating one or more exterior faces of the device 110 about an axis). The display cube device 110 also operates in a “resting” mode in which multimedia content 510 continues to be displayed on the one or more display screens 210 while the device 110 is not being manipulated by a user. In certain embodiments, the display cube device 110 further operates in an energy-saving mode in which only the primary or currently designated main display screen 210 (e.g., a user-facing display screen) is activated to display multimedia content 510. The computer system 200 may switch the cube device 110 between different operating modes automatically in response to user inputs or after a period of inactivity.

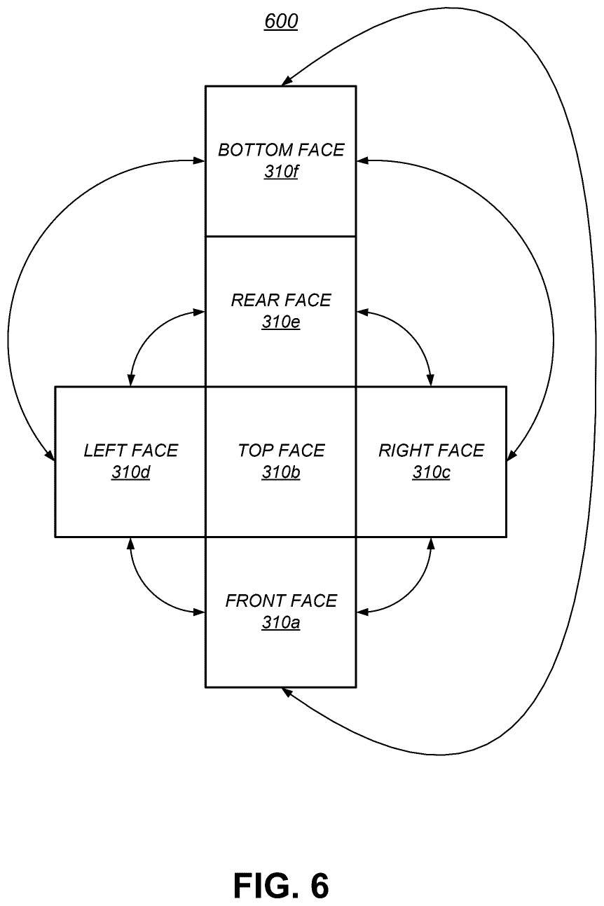

FIG. 6 is a schematic representation of a logical map 600 for updating multimedia content in the graphical user interface (GUI) of FIGS. 5A and 5B. In the primary embodiment, each of the six exterior faces of the cube device 110 (including the front face 310a, the top face 310b, the right-side face 310c, a left-side face 310d, a rear face 310e, and a bottom face 310f) include a display screen 210 for displaying multimedia content 510 in the GUI 500. In certain embodiments, only a subset of the exterior faces (e.g., the top face 310b and the bottom face 310f) include display screens 210. In other embodiments, a subset of the display screens 210 (e.g., non-user-facing display screens) are powered off or inactive when the cube device 110 is in an energy-saving mode.

The logical map 600 illustrates the relationship between the six exterior faces, which a software application of the cube device 110 uses to update multimedia content 510 responsive to rotational inputs. For example, rotation of the top face 310b may update multimedia content 510 displayed in GUIs 500 of the front face 310a, right-side face 310c, left-side face 310d, and rear face 310e. Similarly, rotation of the right-side face 310c may update multimedia content 510 displayed in GUIs 500 of the front face 310a, top face 310b, rear face 310e, and bottom face 310f. If one or more display screens 210 of the six exterior faces are inactive, the cube device 110 may still detect rotational inputs of the corresponding inactive faces. For example, when the right-side face 310c display screen 210 is inactive, the cube device 110 can still update the GUIs 500 of the neighboring faces 310a, 310b, 310e, and 310f.

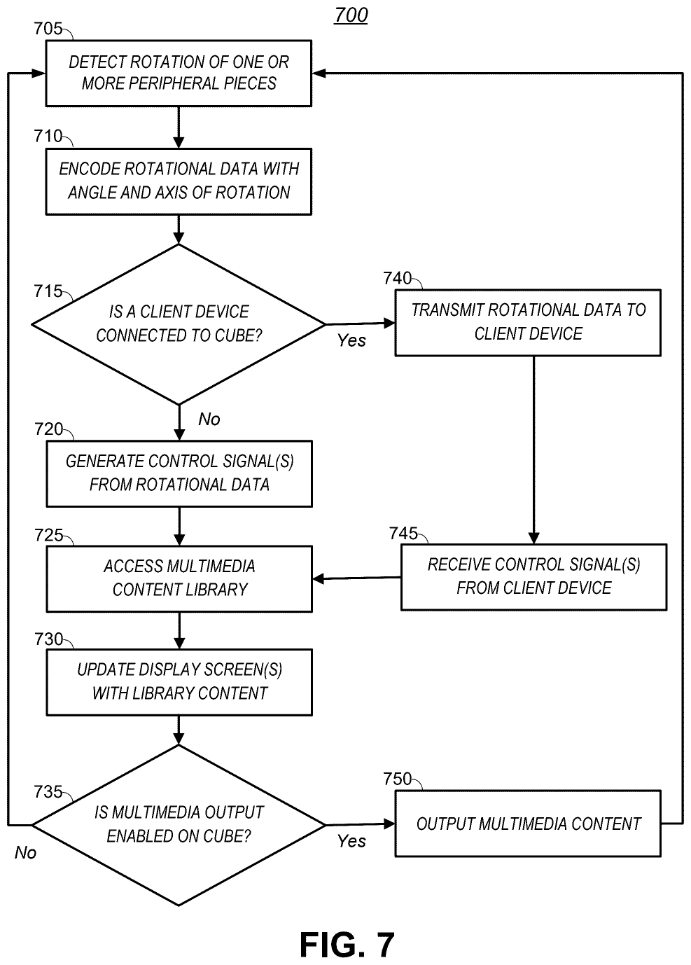

FIG. 7 illustrates steps of a method 700 for dynamically updating content of one or more display screens 210 of the display cube device 110, in accordance with one embodiment. The method 700 may be implemented by computer-readable instructions executed by the cube device 110 (e.g., via the computer system 200), the client device 120 (e.g., the cube device application 125), or a combination thereof. The method 700 causes the cube device 110 to access the multimedia content library 135 (e.g., directly via the network 140 or indirectly via the client device 120) to output updated multimedia content 510 responsive to one or more rotational inputs by the user. In some instances, the content library 135 offers additional computer-readable instructions (e.g., educational programs) for download, which can modify the method 700 with additional steps or new multimedia content 510.

Initially, the method 700 causes the computer system 200 to detect 705 rotation of one or more peripheral pieces (e.g., the edge pieces 320 and corner pieces 330) of the cube device 110 by one or more rotational inputs. The rotational inputs can include, for example, a gyroscope, accelerometer, or rotary encoder configured to generate rotational data of the one or more peripheral pieces indicative of a user input. In one embodiment, the rotational inputs can be a pair of switches configured to detect a direction of rotation of a peripheral piece about one axis. In other embodiments, the rotational inputs can generate detailed rotational data, such as the real-time angle of rotation as the user rotates the plurality of peripheral pieces. The cube device 110 includes a plurality of rotational inputs (e.g., rotary encoders or other inputs integrated into the center piece 460) to detect rotation of each exterior face of the device 110 about an axis.

The method 700 may cause the computer system 200 to encode 710 the rotational data including an axis of rotation, a direction of rotation, and an angle of rotation (if available). The encoded rotational data is used to generate control signals which cause the computer system 200 to update the multimedia content of the display screens 210 accordingly.

In an example, the method 700 determines 715 that the cube device 110 is communicatively connected to a client device 120, causing the cube device 110 to transmit 740 the encoded rotational data to the client device 120 for processing. The client device 120 can process the encoded rotational data to determine which display screens 210 of the cube device 110 need an updated GUI 500 based on the logical map 600. The client device 120 generates and transmits control signals to the cube device 110 indicating which display screens 210 and items of multimedia content 510 need updating (e.g., via a display identifier and a content identifier or index). The control signals may include, for example, a URL or index of one or more items of updated multimedia content 510 to be accessed from the content library 135. In other embodiments, the control signals include relevant multimedia content 510 downloaded from the content library 135 by the client device 120. The cube device 110 receives 745 the control signals from the client device 120.

In another example, the method 700 determines 715 that the cube device 110 is not connected to any client device 120 (or the cube device 110 is connected to a client device 120, but offloading processing to the client device 120 is not currently enabled). The method 700 causes the computer system 200 to generate 720 control signals from the rotational data indicating which display screens 210 and items of multimedia content 510 need updating.

The method 700 causes the computer system 200 to access one or more items of multimedia content 510 from the content library 135. In some cases, the multimedia content 510 is cached by the client device 120 and the cube device 110 accesses the content library 135 indirectly (e.g., via a cache of the client device 120). Protocols used to access the multimedia content 510 can include hypertext transfer protocol (HTTP), file transfer protocol (FTP), real-time transport protocol (RTP), and the like. The multimedia content 510 is downloaded to a computer memory (e.g., the memory 204) from which it is accessed to update 730 a GUI 500 of one or more of the display screens 210.

The method 700 determines 735 whether the cube device 110 is currently configured for multimedia output. In some cases, the multimedia content 510 includes audio or video content, but audio or video outputs of the cube device 110 are not enabled. For example, in a classroom environment, an education professional may decide to disable audio output via a mobile device (e.g., the client device 120) for all paired cube devices 110 when audio playback may be disruptive to the class. In another example, an education professional may designate their own cube device 110 as a demonstration device (with audible outputs) while silencing multimedia outputs on all other devices 110. In an additional example, the method 700 may determine that the cube device 110 is currently in an energy-saving mode and disable playback of video content (e.g., by displaying a preview image of the content instead) to conserve energy. Upon a determination 735 that multimedia output by the cube device 110 is currently enabled, the method 700 causes the computer system 200 to output 750 (e.g., via the signal generation device 218) an audio signal associated with the multimedia content 510. The method 700 returns to its initial state, waiting to detect 705 rotation of one or more peripheral pieces.

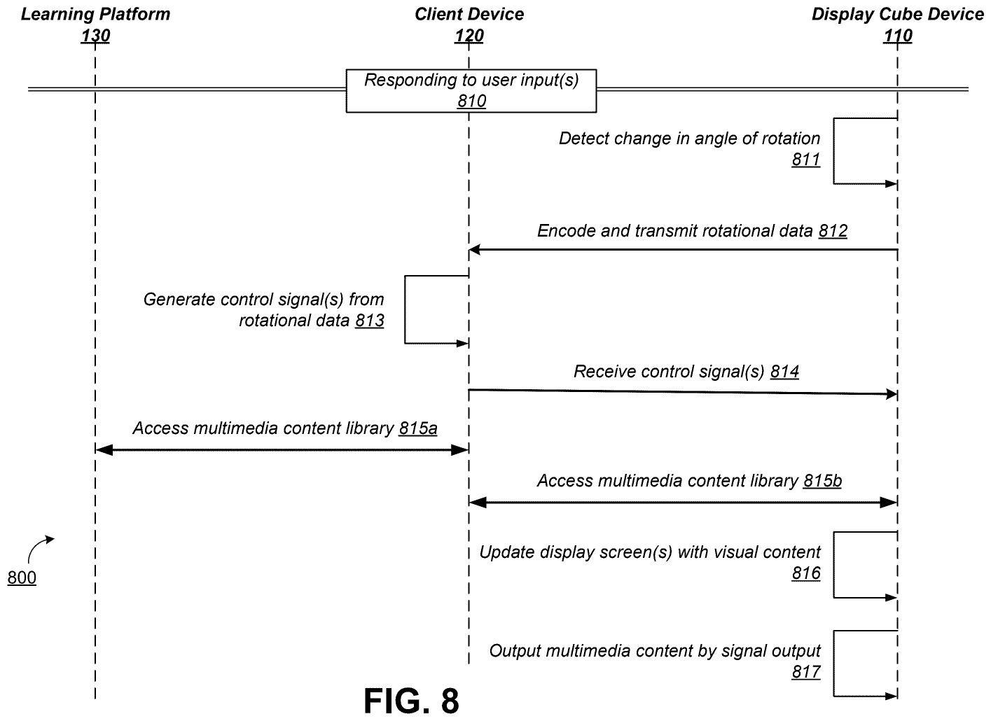

FIG. 8 is a timing diagram illustrating a method 800 of responding to user input by the programmable display cube device 110 of any of the previous figures, according to one embodiment. The timing diagram captures multiple phases of content retrieval performed by the cube device 110 and a client device 120 in order to update display content in a GUI (e.g., the GUI 500) of a display screen (e.g., the display screen 210) in cooperation with the learning platform 130. In addition to the order depicted in FIG. 8, certain operations of the timing diagram may be performed in alternative orders or in parallel. Although FIG. 8 depicts an embodiment wherein multimedia content is accessed from a content library 135 hosted by a learning platform 130, in some instances, the learning platform 130 is a content generation platform configured to serve generated content (e.g., user-generated content or content generated by one or more algorithms or generative AI models) to the cube device 110.

The method 800 begins with the cube device 110 detecting 811 a change in an angle of rotation of one or more faces of the cube device 110 (e.g., step 705 of the method 700). The cube device 110 encodes and transmits 812 rotational data of the one or more faces to the client device 120 (e.g., step 710 and step 740 of the method 700). The client device 120 generates 813 control signals to cause the cube device 110 to update one or more display screens (e.g., the display screen 210) based on the rotational data and the logical map 600. The client device 120 transmits the control signals to be received 814 by the cube device 110 (e.g., step 745 of the method 700).

The client device 120 may also access 815a the content library 135 of the learning platform 130 (e.g., by an application programming interface (API)) to download relevant multimedia content according to the control signals and specific display screen(s) 210 to be updated. The client device 120 caches the multimedia content locally for the cube device 110 to promptly access 815b the content to update the display screen(s) 210. In certain embodiments, the cube device 110 accesses 815 the relevant multimedia content directly from the content library 135 according to the control signals (e.g., step 725 of the method 700). The control signals may include, for example, a URL or index of each item of multimedia content to be accessed from the content library 135 or from local storage. In other embodiments, the client device 120 transmits the control signals to the learning platform 130 as well as to the cube device 110, causing the learning platform 130 to preemptively cache the relevant content to be accessed 815 by the cube device 110.

Upon accessing the relevant multimedia content, the cube device 110 updates 816 the one or more display screens 210 accordingly (e.g., step 730 of the method 700). For example, the computing system of the cube device 110 can transmit one or more items of multimedia content to each display screen 210 to be updated. The multimedia content may be modified (e.g., cropped or scaled) to render correctly in a GUI of each display screen 210. In some cases, processing to prepare the multimedia content for display may be performed onboard the client device 120 (i.e., offloaded) such that the computing system of the cube device 110 performs minimal processing to render the updated GUI. The cube device 110 outputs 817 a multimedia component of the content (e.g., by the signal generation device 218) if the device 110 currently has multimedia output enabled (e.g., step 750 of the method 700).

Those skilled in the art will envision additional structural and functional designs for a system and a process for providing the described functionality. Thus, while particular embodiments and applications have been illustrated and described, it is to be understood that the described subject matter is not limited to the precise construction and components disclosed.

### Example Software Applications of a Programmable Display Cube Device

As discussed above, a display cube device 110 may be used in connection with one or more paired client devices 120. For example, when a plurality of display cube devices 110 are used in an educational setting, each student in a classroom might use a separate cube device 110 (or multiple students might share a cube device 110), and each of the plurality of display cube devices 110 may be communicatively coupled to a common client device 120 (e.g., a mobile device used by a teacher). The pairing of one or more cube devices 110 to a client device 120 allows a user of the client device 120 to select content for display on the cube devices 110. For example, a teacher can select questions or prompts on a range of topics from a content library accessed via the network 140 (e.g., a multimedia content library hosted by the learning platform 130) for display on student cube devices 110 and receive feedback on the client device 120 regarding students' responses to the displayed prompts.

Via a user interface of the cube device application 125, the user of the client device 120 may indicate content (e.g., multimedia content including textual, pictographic, video, and/or audio content) for display on the one or more cube devices 110. The indication may include, for example, a selection of a question or a series of questions on a topic selected from the content library 135 of the learning platform 130 or provided by the user. The user of the client device 120 may also view, through the cube device application, usage data (e.g., responses to questions displayed on one or more paired cube devices 110) and access data-driven feedback generated from the usage data, such as response statistics (e.g., identifying areas of strength or weakness for a student), timing data (e.g., how long it took one or more students to answer a question or complete a series of questions), scoring or grading data, and the like.

In certain embodiments, two or more display cube devices 110 may be communicatively coupled to each other (e.g., in a peer-to-peer configuration) to allow users of the cube devices 110 to share content with each other and collaborate to answer questions or solve puzzles. For example, in a collaborative solving mode, each participating cube device 110 is assigned a different portion (e.g., a face) of a collaborative puzzle, and users communicate with each other to coordinate input and solve the puzzle together, fostering teamwork and problem-solving skills. In another example, cube devices 110 operate in a “mirror mode,” in which manipulation of a first cube device 110 is mirrored on display screens of a second cube device 110.

In some embodiments, an audio output or haptic output (e.g., via the cube device application 125 of the client device 120 or via the signal generation device 218 of the cube device 110) is used to provide information to the user, for example, to indicate that a configuration is correct or incorrect. For instance, where the cube device 110 is being used to help teach phonetics, letters may be displayed in a first portion of a GUI of a display screen 210 (e.g., a first row) the cube device 110, and letter sounds may be displayed in a second portion of the GUI of the display screen 210 (e.g., a second row). When the user of the cube device 110 correctly rotates one or more peripheral pieces of the cube device 110 to match each letter with its corresponding letter sound (e.g., aligning the content correctly in each column of the GUI), an audio output and/or a haptic output can be provided (e.g., via the cube device application 125 of the client device 120) to indicate to the user that the configuration is correct and, optionally, provide an explanation (e.g., “Sound C is made by closing the tongue against the alveolar ridge (the ridge behind the upper teeth) and then releasing the air, which causes the vocal cords to vibrate.”). Conversely, if the configuration provided by the user is incorrect, audio output may prompt the user to try again or provide a hint to help the user reach the correct answer. In some cases, symbols or colors may be updated in a third portion of the GUI of the display screen 210 (e.g., a third row) to visually indicate a correct (or incorrect) configuration. The phonetics software application may be readily adapted to teach one or more languages, particularly tonal languages such as Mandarin Chinese.

In another embodiment, an audio output may be a prompt or question for the user of the cube device 110 to respond to. For instance, when the cube device 110 or client device 120 is running a “Language Translator” application, an audible word or phrase in a first language may be output (e.g., via the cube device application 125 of the client device 120 or via the signal generation device 218 of the cube device 110). The user rotates a plurality of peripheral pieces corresponding to rows or columns of the cube device 110 until text content corresponding to the spoken word or phrase is displayed in a GUI of a display screen 210 on the front exterior face 310a of the cube device 110.

In some cases, the software application may prompt a student with a question (e.g., via the cube device application 125 of the client device 120) while a display screen 210 of the cube device 110 displays two or more potential answers (e.g., words) in each row of the GUI (e.g., in a multiple-choice format). The student rotates an exterior face of the cube device 110 such that the row containing the correct answer is “moved” to a different display screen 210 presenting a related concept (e.g., a phonetic symbol corresponding to the pronunciation of the word). For example, the software application may read an incomplete sentence aloud and ask the user to identify the word or phrase which best completes the sentence. In other cases, the software application may prompt a student with a single word, and the student is tasked with rotating an exterior face of the cube device 110 such that a corresponding phonetic transcription is displayed in the GUI of the same display screen 210 as the word.

The software application may also prompt the user with binary choices (e.g., true-or-false or yes-or-no questions) by displaying two possible options in the GUI of the display screen 210 for the user to respond. For example, a prompt may be displayed in a middle row of the GUI, a “true” response displayed in a top row of the GUI, and a “false” response displayed in a bottom row of the GUI, wherein the user rotates the top face 310b of the cube device 110 to indicate “true” or rotates the bottom face 310f of the cube device 110 to indicate “false”. In other cases, the user may indicate their selection based on the direction of a rotational input (e.g., a clockwise rotation of the top face 310b indicates “true” while a counterclockwise rotation of the top face 310b indicates “false”). The GUI may include colors or symbols (e.g., arrows) indicating a direction of rotation corresponding to each binary selection.

In yet another embodiment, an audio output may be a narrative (e.g., a story) or a description (e.g., a recorded lecture) which is output (e.g., via the cube device application 125 of the client device 120 or via the signal generation device 218 of the cube device 110) while text content including a transcription of the audio output is displayed in a GUI of a display screen 210 of the front exterior face 310a of the cube device 110. The text content can “scroll” or otherwise move from the GUI of the display screen 210 of the front exterior face 310a of the cube device 110 to a GUI of a different display screen 210 (e.g., a display screen of any of the exterior faces 310b-310f). If the user wishes to re-read a previous portion of the text content (or re-play the corresponding portion of the audio output), the user may rotate one or more peripheral pieces of the cube device 110 to reverse the movement of the text content.

Various examples of software applications (e.g., educational programs, games, tools, etc.) executed by the cube device 110, client device 120, learning platform 130, or a combination thereof will now be discussed. Software applications may incorporate any of the GUI elements or methodologies discussed herein.

Software applications may be educational programs that teach various subjects including, but not limited to, linguistics (e.g., phonetics, morphologies, inflection and derivation, word combinations, syntax, semantics, pragmatics, prefixes, suffixes, roots, etc.), language learning (e.g., translating words and phrases between different languages or dialects, or matching words and phrases to colors, symbols, images, audio, or video), literature (e.g., matching literary text to an audio output, or matching the text to its author), composition (e.g., matching text to an associated writing style), mathematics (e.g., solving arithmetic equations, identifying properties of geometric shapes, performing matrix manipulations, etc.), biology (e.g., identifying components of cell diagrams, genetic sequences, anatomical diagrams, etc.), chemistry (e.g., balancing chemical equations, identifying molecules by structural formulae, identifying chemical bonds, etc.), physics (e.g., solving equations in statics and dynamics, electricity and magnetism, fluids and thermodynamics, optics, acoustics, astronomy, etc.), history (e.g., matching historical figures, civilizations, landmarks, events, dates etc.), geography (e.g., mapping geographic locations to different faces of the cube device 110), civics (e.g., matching politicians, government buildings, landmarks, maps, etc.), economics (e.g., matching economists and economic theories or principles), art (e.g., matching artists and their works or techniques), music (e.g., mapping audio outputs and musical notes or clefs to different faces of the cube device 110), computer science and programming (e.g., demonstrating algorithms, theorems, models, etc.), special education concepts (e.g., sensory integration puzzles, communication aids, color and shape recognition, motor skills training, cooperative lessons, etc.), and the like.

In various embodiments, the cube device 110, client device 120, learning platform 130, network 140, and/or network system 150 integrate artificial intelligence (AI) technologies to provide personalized learning experiences to users, analyze data on user performance and provide tailored support, and automate tasks, such as grading assignments or quizzes. In an embodiment, AI technologies may include generative AI models configured for interactive content generation (e.g., via a content generation platform accessed via the network 140). For example, a generative AI model may modify a software application for a cube device 110 based on a math teacher's request to include more content related to factoring polynomials in their curriculum. In another example, the generative AI model may create a new software application for the cube device 110 by generating multimedia content for display in the GUI(s) based on the teacher's description. AI technology may further augment the functionality of the software applications described above by providing, for example, data-driven insights and personalized tutoring to identify and address gaps in student learning.

In some embodiments, usage data of the display cube device 110 may be used to train an AI model (e.g., a generative AI model such as a large language model). The AI model may be stored and/or managed by the cube device 110 (e.g., as part of an educational program), the client device 120 (e.g., as part of the cube device application 125), the learning platform 130, one or more remote servers (e.g., as part of a content generation platform), or a combination thereof. In various embodiments, one or more systems or methods of the display cube device 110 as described herein may be implemented by the AI model.

The AI model may be instantiated as one or more AI agents configured to perform specific tasks. For example, an AI model trained on curriculum data (e.g., display content associated with one or more educational programs) and student usage data of the display cube device 110 may be instantiated as a teacher's aide agent. The teacher's aide agent may provide hints or feedback (e.g., via audio, visual, or haptic outputs) to guide a user based on their interactions with the display cube device 110. The teacher's aide agent may offer tailored assistance based on the user's educational proficiencies and weaknesses. In some instances, the AI model underlying the teacher's aide agent may undergo re-training as more usage data of the display cube device 110 is collected, such as usage data from a teacher performing a demonstration. Those skilled in the art will envision additional possibilities for various AI agents. More generally, a plurality of AI agents may be instantiated based on one or more AI models (e.g., a unique AI agent for each student or a different AI agent for each subject being taught by the display cube device 110).

Software applications may also be video games or other entertainment programs played via the cube device 110. Examples of games include navigation games (e.g., navigating a player avatar around obstacles), decision making games, matching and merging games (e.g., accumulating a higher score by combining matching tiles), cube solving games (e.g., causing each face of the cube device 110 to display the same color or symbol), time challenges, chess or checkers, tic-tac-toe, sudoku, crossword puzzles, ring collecting games, virtual pet games, chronology games, musical games, memory games, maze games, drawing games, simulation games, miniature golf games, image unscrambling games, astronomy games, reflex games (e.g., rapidly responding to a musical rhythm or objects appearing in the GUI), countdown games, code solving games, pattern recognition games, trivia games, or any other game or puzzle known to those skilled in the art. In certain embodiments, a GUI of the cube device 110 may display a menu for selecting one or more games or gameplay modes (e.g., adjusting game difficulty, starting time challenges, or enabling collaborative play). In various embodiments, the games may be collaborative games (e.g., mirroring multimedia content and rotational inputs between two or more cube devices 110).

In some instances, the cube device 110 may be an input device for a virtual reality or augmented reality (AR/VR) application. For example, the client device 120 may be a virtual reality headset which is communicatively connected (e.g., paired) to the cube device 110. The client device 120 can receive input data from the cube device 110 (e.g., rotational inputs, acceleration data, or a relative location of the cube device 110 using object-tracking cameras) and update the user's virtual environment accordingly. The client device 120 can also update the GUI of each display screen 210 of the cube device 110, such as by changing a color of the GUI to indicate when a user's special ability is available. The AR/VR-enabled cube device 110 can further enhance the educational or entertainment programs discussed above, providing a more immersive experience with three-dimensional display content (e.g., simulated environments) which supplement the display content of the display screens 210.

Software applications may further include one or more internet-of-things (IoT)-enabled tools to assist the user in accessing information from the internet (e.g., the network 140) or their paired smartphone (e.g., the client device 120) via the cube device 110. One or more of the software applications may be activated automatically when the cube device 110 is in an inactive state (e.g., an energy-saving mode) or after a timeout period. In various embodiments, the software application may be a weather application (e.g., displaying the temperature and weather forecast), a clock application (e.g., displaying the time, a timer countdown, or an alarm), a photos application (e.g., displaying a slideshow of images accessed from the client device 120), a stocks application (e.g., displaying one or more stocks or index funds), a calendar application (e.g., displaying upcoming events from a digital calendar of the client device 120), a notifications application (e.g., mirroring messages, calls, emails, or other notifications from the client device 120), a music or radio application (e.g., displaying an interface for activating playback of audio from the client device 120 or via the network 140), a news application (e.g., displaying headlines from the client device 120 or via the network 140), a fitness application (e.g., displaying health and fitness statistics from the client device 120), social applications (e.g., displaying a newsfeed or recent social media interactions), and the like. In an embodiment, the user interacts with a digital assistant of the client device 120 by speaking to the cube device 110. In some instances, the cube device 110 and/or the client device 120 may execute two or more software applications simultaneously, such as by displaying the clock application in a first GUI of the cube device 110, displaying the weather application in a second GUI of the cube device 110, and displaying the radio application in a third GUI of the cube device 110.

### ADDITIONAL CONSIDERATIONS

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A programmable display cube device comprising:
a center piece comprising a microprocessor, a power source, and a communications module for controlling display of content by the display cube device;
a plurality of peripheral pieces disposed around the center piece and configured to rotate about a first axis of the center piece in response to manipulation of the device by a user; and
at least one display screen provided on at least one exterior face of the display cube device and communicatively connected to the microprocessor;
wherein the display screen is centered on the first axis of the center piece such that a first subset of the plurality of peripheral pieces provided adjacent to the display screen is rotatable about the first axis of the center piece and a second axis of the center piece.

2. The programmable display cube device of claim 1, wherein the display cube device is communicatively connected to a client device; and
wherein content is displayed on the display screen of the display cube device responsive to one or more control signals generated by the client device.

3. The programmable display cube device of claim 2, wherein the display cube device is further configured to:
detect an angle of rotation of the plurality of peripheral pieces;
generate rotational data comprising the angle of rotation and an axis of rotation;
receive, by the communications module, one or more control signals from the client device responsive to the rotational data; and
update, by the microprocessor, content on the display screen responsive to the one or more control signals received from the client device.

4. The programmable display cube device of claim 1, further comprising two or more displays screens provided on two or more outer faces of the display cube device, wherein each of the two or more display screens are centered on a respective axis of the center piece.

5. The programmable display cube device of claim 4, wherein the display cube device is operating in an energy-saving mode; and
wherein a user-facing display screen of the two or more display screens is configured to display content to a user, and wherein a non-user-facing display screen of the two or more display screens is disabled in the energy-saving mode.

6. The programmable display cube device of claim 4, wherein the microprocessor is configured to update content displayed on the two or more display screens based on relative rotation of the two or more outer faces of the display cube device.

7. The programmable display cube device of claim 4, wherein each exterior face of the display cube device is provided with a single display screen centered on a respective axis; and
wherein the microprocessor is configured to update content displayed on one or more of the display screens responsive to an angle of rotation of the plurality of peripheral pieces and an orientation of the display cube device.

8. The programmable display cube device of claim 2, wherein the communications module is wirelessly connected to the client device by way of Bluetooth, Wi-Fi, near-field communication (NFC), or ultra-wideband (UWB) protocols.

9. The programmable display cube device of claim 8, wherein the communications module is configured to transmit positional or orientational data of the display cube device to the client device.

10. A non-transitory computer-readable storage medium comprising stored instructions, the instructions when executed by a computing system cause the computing system to perform operations comprising:
detecting a change in an angle of rotation of a peripheral piece of a first face indicating input by a user;
encoding rotational data comprising the angle of rotation and an axis of rotation of the peripheral piece;
accessing a content library responsive to the input by the user; and
updating a display screen with one or more items of content from the content library according to the encoded rotational data.

11. The non-transitory computer-readable storage medium of claim 10, wherein accessing the content library further comprises downloading multimedia content from a content platform.

12. The non-transitory computer-readable storage medium of claim 11, wherein updating a display screen with one or more items of content from the content library further comprises:
displaying, by the display screen, a visual component of the multimedia content; and
outputting, by a signal generation device communicatively connected to the computing system, an audio component of the multimedia content.

13. The non-transitory computer-readable storage medium of claim 10, wherein the instructions further comprise instructions that when executed by the computing system cause the computing system to perform operations comprising:
transmitting the encoded rotational data to a client device; and
receiving, from the client device, a control signal comprising a display identifier and a content identifier indicating updated content to be displayed on a corresponding display screen.

14. The non-transitory computer-readable storage medium of claim 13, wherein updating a display screen with one or more items of content from the content library further comprises:
downloading, from the content library, two or more items of multimedia content;
updating a first display screen associated with a first display identifier to display a first multimedia content associated with a first content identifier; and
updating a second display screen associated with a second display identifier to display a second multimedia content associated with a second content identifier.

15. A computer system comprising:
a display cube device configured to:
detect an angle of rotation of a plurality of peripheral pieces comprising an exterior face of the display cube device;
encode rotational data comprising the angle of rotation and an axis of rotation; and
update content displayed in a graphical user interface of two or more display screens of the display cube device responsive to a control signal;
wherein a first display screen is centered on a first axis of the display cube device and a second display screen is centered on a second axis of the display cube device such that a subset of the plurality of peripheral pieces disposed adjacent to the first display screen and the second display screen are rotatable about the first axis and the second axis; and
a client device configured to:
receive, from the display cube device, encoded rotational data;
determine, based on the angle of rotation and the axis of rotation, updated display content for display in the graphical user interface of the two or more display screens;
generate one or more control signals to cause the display cube device to display the updated display content in an updated graphical user interface; and
transmit the one or more control signals to the display cube device.

16. The computer system of claim 15, wherein the client device is another display cube device.

17. The computer system of claim 15, wherein the client device is communicatively connected to the display cube device and a platform server device hosting a content library.

18. The computer system of claim 17, wherein the client device executes a cube device application to cause the client device to access the content library via a network and serve the updated display content to the display cube device.

19. The computer system of claim 18, wherein the client device is communicatively connected to a plurality of display cube devices, and wherein the cube device application is configured to generate data-driven insights based on usage data of each display cube device.

20. The computer system of claim 19, wherein the data-driven insights include response statistics, timing data, and scoring or grading data for a plurality of users of the plurality of display cube devices.
